(19) United States
(12) Patent Application Publication
(10) Pub. No.: US 2019/0056357 A1
(43) Pub. Date: Feb. 21, 2019

(54) FLUID AERATION SENSOR AND METHOD OF OPERATING THE SAME

(71) Applicant: SSI Technologies, Inc., Janesville, WI (US)

(72) Inventors: Lawrence B. Reimer, Georgetown, SC (US); Gregory P. Murphy, Janesville, WI (US)

(21) Appl. No.: 15/682,038

(22) Filed: Aug. 21, 2017

(51) Int. Cl. G01N 29/024

(52) U.S. Cl. CPC G01N 29/024; G01N 29/028

(57) ABSTRACT

A fluid sensing system including a first transducer, a second transducer, a filter, and a controller. The first transducer is configured to output a first sound wave through a first fluid in a first measurement channel. The second transducer is configured to output a second sound wave through a second fluid in a second measurement channel. The filter is configured to substantially prevent aeration in the second fluid contained within the second measurement channel. The controller is configured to determine a first characteristic of the first sound wave, and determine a second characteristic of the second sound wave. The controller is further configured to determine a percentage of aeration by volume within the first fluid based on the first characteristic and second characteristic, and output the percentage of aeration by volume within the first fluid.

### FIELD

Embodiments relate to fluid sensing systems and sensors.

### SUMMARY

Fluid sensing systems are configured to sense one or more characteristics of a fluid (for example, a hydraulic fluid, a diesel exhaust fluid (DEF), a brake fluid, oil, fuel, a transmission fluid, a washer fluid, a power steering fluid, a refrigerant, etc.). In some circumstances, the fluid may become aerated. Aerated fluids may cause several issues, such as false characteristic readings and failure of components.

Thus, one embodiment provides a fluid sensing system including a first transducer, a second transducer, a filter, and a controller. The first transducer is configured to output a first sound wave through a first fluid in a first measurement channel. The second transducer is configured to output a second sound wave through a second fluid in a second measurement channel. The filter is configured to substantially prevent aeration in the second fluid contained within the second measurement channel. The controller is configured to determine a first characteristic of the first sound wave, and determine a second characteristic of the second sound wave. The controller is further configured to determine a percentage of aeration by volume within the first fluid based on the first characteristic and second characteristic, and output the percentage of aeration by volume within the first fluid.

In another embodiment provides a method of sensing a fluid. The method includes outputting, via a first transducer, a first sound wave through a first fluid and outputting, via a second transducer, a second sound wave through a second fluid, wherein the second fluid is filtered. The method further includes determining, via a controller, a first characteristic of the first sound wave, and determining, via the controller, a second characteristic of the second sound wave. The method further includes determining, via the controller, a percentage of aeration by volume within the first fluid based on the first characteristic and the second characteristic, and outputting the percentage of aeration by volume within the first fluid.

Other aspects of the application will become apparent by consideration of the detailed description and accompanying drawings.

### BRIEF DESCRIPTION OF THE DRAWINGS

FIG. 1 illustrates a sensing system configured to sense one or more characteristics of a fluid within a tank according to some embodiments.

FIG. 2 illustrates a side view of the sensing system of FIG. 1 according to some embodiments.

FIG. 3A illustrates a side view of the sensing system of FIG. 1 according to another embodiment.

FIG. 3B illustrates a top view of the sensing system of FIG. 3A according to some embodiments.

FIG. 4 illustrates a block diagram of a control system of the sensing system of FIG. 1 according to some embodiments.

FIG. 5 illustrates a process or operation of the sensing system of FIG. 1 according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

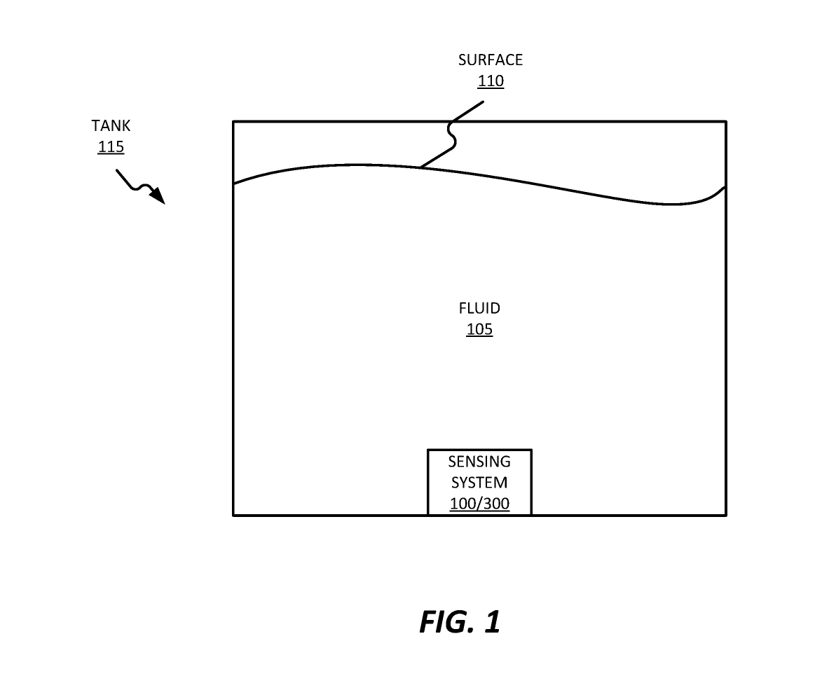

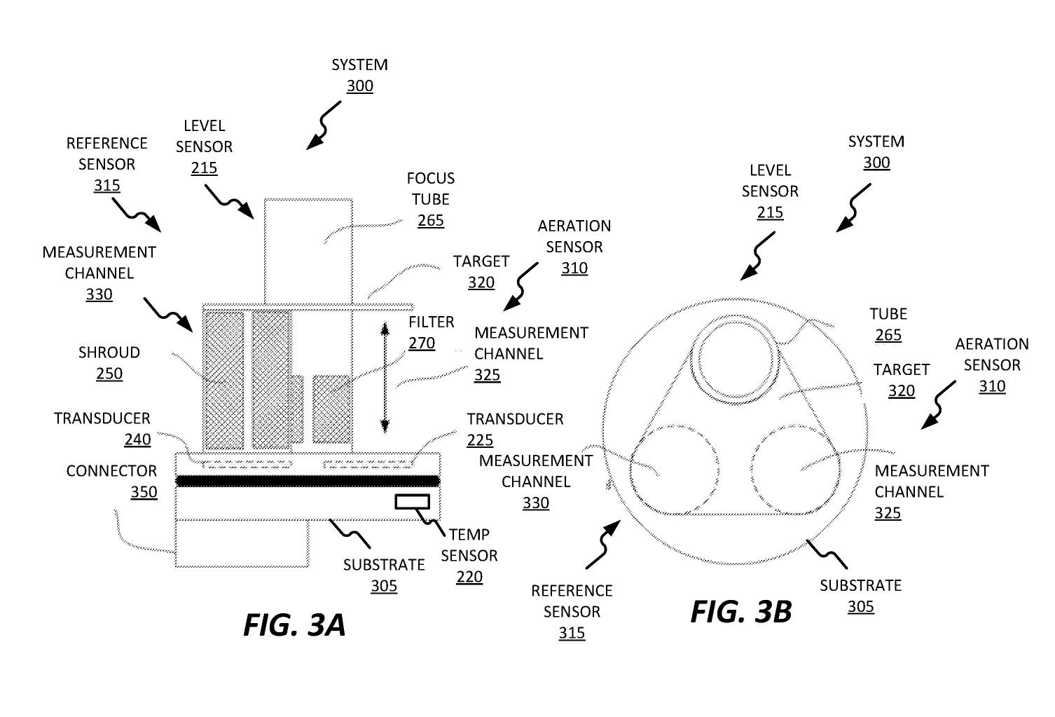

FIG. 1 illustrates a sensing system 100 according to some embodiments. The sensing system 100 is configured to sense one or more characteristics of a fluid 105 having a surface 110 contained within a tank 115. The fluid 105 may be, for example, a hydraulic fluid, a diesel exhaust fluid (DEF), a brake fluid, oil, fuel, a transmission fluid, a washer fluid, a power steering fluid, a refrigerant, etc. Although illustrated as being located at the bottom of the tank 115, sensing system 100 (or sensing system 300 of FIG. 3) may be located at another location of the tank 115 (for example, at a side wall of the tank 115).

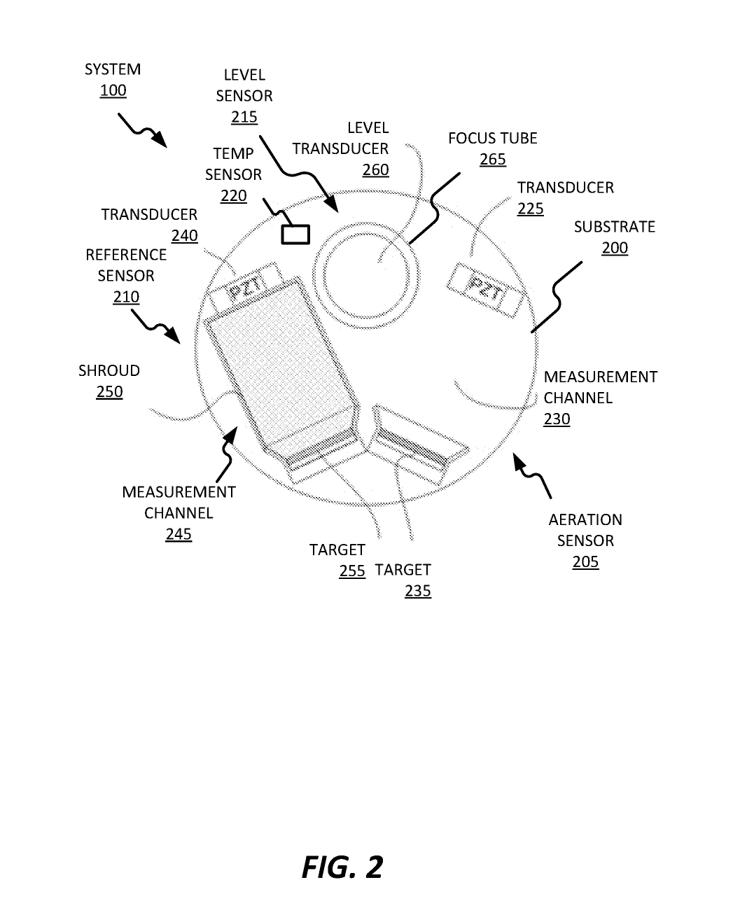

FIG. 2 illustrates the sensing system 100 according to some embodiments. In the example illustrated, sensing system 100 includes a substrate 200 configured to secure an aeration sensor 205, a reference sensor 210, a level sensor 215, and a temperature sensor 220. The substrate 200 may be, or may include, a printed-circuit board (PCB).

The aeration sensor 205 is configured to sense one or more characteristics (for example, an aeration sonic transmissivity (ST)) of an aerated portion of the fluid 105. In one example, the aeration sensor 205 includes an aeration transducer 225, an aeration measurement channel 230, and an aeration target 235. The transducer 225 acts as both a transmitter and a receiver. In some embodiments, transducer 225 is an ultrasonic transducer (for example, a piezoelectric ultrasonic transducer (PZT)). In other embodiments, the transducer 225 may be an optical and/or laser transducer.

In operation, the transducer 225 outputs a sound wave through the aerated portion of the fluid 105 contained within the measurement channel 230. The sound wave travels toward the target 235 and is reflected back toward the transducer 225. The transducer 225 determines an aeration time-of-flight of the sound wave. In the illustrated embodiment, the sound wave travels in a horizontal direction (for example, in a parallel direction to a bottom of the tank 115).

The reference sensor 210 is configured to sense one or more characteristics (for example, a reference ST) of a substantially non-aerated portion of the fluid 105. The reference sensor 210 includes a reference transducer 240, a reference measurement channel 245, a shroud 250, and a reference target 255. The transducer 240 acts as both a transmitter and a receiver. In some embodiments, transducer 240 is an ultrasonic transducer (for example, a piezoelectric ultrasonic transducer (PZT)). In other embodiments, the transducer 240 may be an optical and/or laser transducer.

The shroud 250 is configured to substantially prohibit, or reduce, aeration of the fluid 105 within the measurement channel 245. In some embodiments, the shroud 250 substantially prohibits aeration (for example, approximately 90% or greater of the fluid within the measurement channel 245 is in the form of liquid) by preventing the flow of gas (for example, one or more air bubbles) into measurement channel 245. In some embodiments, the shroud 250 includes a mesh screen formed of a synthetic polymer (for example, nylon, polyethylene, polypropylene, etc.). In some embodiments, the shroud 250 may include a textured area, or a tortuous path, configured to direct a flow of gas away from the measurement channel 245, while allowing a flow of liquid toward the measurement channel 245.

In operation, measurement channel 245 receives the substantially non-aerated portion of fluid 105. Transducer 240 outputs a second sound wave through the substantially non-aerated portion of the fluid 105 contained within measurement channel 245. The second sound wave travels toward the target 255 and is reflected back toward the transducer 240. The transducer 225 determines a reference time-of-flight of the second sound wave. In the illustrated embodiment, the second sound wave travels in a horizontal direction (for example, in a perpendicular direction to a bottom of the tank 115). In some embodiments, the reference time-of-flight may be used to determine a concentration, a viscosity, a quality, and/or a specific gravity of the fluid 105.

The level sensor 215 is configured to sense a level of the surface 110 and/or a quantity of the fluid 105 within the tank 115. The level sensor 215 includes a level transducer 260 and a tube, or focus tube, 265. The transducer 260 acts as both a transmitter and a receiver. In some embodiments, transducer 260 is an ultrasonic transducer (for example, a piezoelectric ultrasonic transducer (PZT)). In other embodiments, the transducer 260 is an optical and/or laser transducer. In some embodiments, the level sensor 215 includes a float configured to float on the surface 110 of the fluid 105. In still other embodiments, level sensor 215 includes a filter 270 (FIG. 3A). In such an embodiment, the filter 270 may include similar components, and perform a similar function, as shroud 250. For example, the filter 270 may substantially prohibit a flow of gas into the tube 265.

In operation, transducer 260 outputs a sound wave toward the surface 110, or float located on the surface 110. The sound wave is reflected off of the surface 110, or float, and travels back to the transducer 260. The transducer 260 determines a time-of-flight of the sound wave, which may be used to determine a level and/or quantity of the fluid 105 within the tank 115.

The temperature sensor 220 senses a temperature of the fluid 105 within the tank 115. Sensors suitable for use as the temperature sensor 220 include thermocouples, thermistors resistive temperature sensor, and an infrared temperature sensor.

FIGS. 3A & 3B illustrate a sensing system 300 according to another embodiment. Sensing system 300 may include a substrate 305 configured to secure an aeration sensor 310, a reference sensor 315, a level sensor 215, a temperature sensor 220, and a target, or reflector, 320. Substrate 305 may be substantially similar to substrate 200.

Aeration sensor 310 may include similar components as aeration sensor 205, for example, transducer 225. Aeration sensor 310 may also include an aeration measurement channel 325. Reference sensor 315 may include similar components as reference sensor 210, for example, transducer 240 and shroud 250. Reference sensor 315 may also include a reference measurement channel 330. In such an embodiment, shroud 250 may be configured to prohibit, or reduce, aeration of the fluid 105 within the measurement channel 330 in a similar manner as described above. Target 320 may be configured to reflect a sound wave from transducer 225 and/or transducer 240. In the illustrated embodiment, target 320 may be coupled to focus tube 265 of level sensor 215.

In operation, the transducer 225 outputs a sound wave through the aerated portion of the fluid 105 contained within the measurement channel 325. The sound wave travels toward the target 320 and is reflected back toward the transducer 225. The transducer 225 determines an aeration time-of-flight of the sound wave. In the illustrated embodiment, the sound wave travels in a vertical direction (for example, in a parallel direction to a bottom of the tank 115).

In operation, measurement channel 330 receives the substantially non-aerated portion of fluid 105. Transducer 240 outputs a second sound wave through the substantially non-aerated portion of the fluid 105 contained within measurement channel 330. The second sound wave travels toward the target 320 and is reflected back toward the transducer 240. The transducer 240 determines a reference time-of-flight of the second sound wave. In the illustrated embodiment, the second sound wave travels in a vertical direction (for example, in a perpendicular direction to a bottom of the tank 115). In some embodiments, the reference time-of-flight may be used to determine a concentration, quality, and/or specific gravity of the fluid 105.

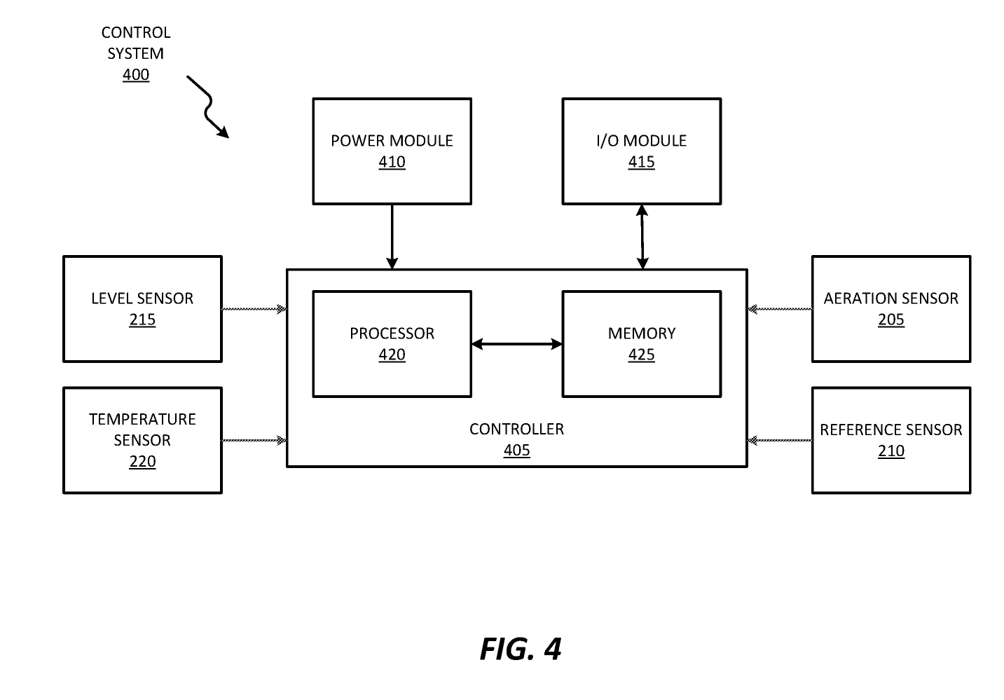

FIG. 4 illustrates a control system 400 of sensing system 100 and/or sensing system 300 according to some embodiments. In some embodiments, the control system 400 is contained, partially or completely, on or within the substrate 200, 305. The control system 400 includes a controller 405, a power module 410, and an input/output (I/O) module 415.

The controller 405 includes an electronic processor 420 and memory 425. The memory 425 stores instructions executable by the electronic processor 420. In some instances, the controller 405 includes one or more of a microprocessor, digital signal processor (DSP), field programmable gate array (FPGA), application specific integrated circuit (ASIC), or the like. The control system 400, via the controller 405, is communicatively coupled to the aeration sensor 205/310, the reference sensor 210/315, the level sensor 215, and/or the temperature sensor 220.

The power module 410 receives power and outputs a nominal power to the controller 405. In the illustrated embodiment, the power module 410 receives power from an external device (for example, a vehicle or vehicle power system). In other embodiments, the power module 410 may receive power from another power source, for example, a battery and/or a renewable power source. The I/O module 415 provides wired and/or wireless communication between controller 405 and the external device. In some embodiments, the controller 405 may be communicatively and/or electrically connected to the external device via connector 350 (FIG. 3A).

In operation, controller 405 controls transducers 225 and 240 to output one or more aeration soundwaves and one or more reference soundwaves, respectively. The one or more aeration soundwaves and the one or more reference soundwaves are reflected from targets (for example, targets 235, 255, and/or 320) and reflected back toward transducers 225 and 240 as aeration echoes and reference echoes. In some embodiments, transducers 225 and 240 output a predetermined number of soundwaves and receive a predetermined number of echoes (for example, one echo, five echoes, or one to ten echoes).

Controller 405 receives an indication from transducers 225 and 240 that one or more echoes have been received. The controller 405 may determine a figure of merit (FOM) strength and a FOM consistency for each aeration echo and each reference echo. In some embodiments, the FOM strength is an indication of strength of each echo received by transducers 225, 240. In such an embodiment, the FOM strength for each echo may be assigned a number zero to n (for example, five), with zero indicating the lowest FOM strength and n indicating the highest FOM strength.

In some embodiments, the FOM consistency is an indication of the consistency of each echo received by transducers 225, 240. In such an embodiment, the FOM consistency may be determined by comparing an echo's ToF to a median of each echo's ToF. In such an embodiment, the FOM consistency for each echo may be assigned a number zero to n (for example, five), with zero indicating the lowest FOM consistency and n indicating the highest FOM consistency.

Controller 405 may further determine a transmit energy for each soundwave output by transducers 225, 240. In some embodiments, the transmit energy is determined based on a voltage applied to the respective transducer (transducers 225, 240) and the quantity of pulses necessary to create a stable echo return. Additionally, controller 405 may further determine an echo amplitude for each echo received by transducers 225, 240.

Controller 405 may further determine a sonic transmissivity (ST) of fluid 105. The ST of the fluid 105 may be a determination of energy needed for soundwaves to travel through fluid 105. In some embodiments, the sonic transmissivity of the fluid 105 is determined based on the transmit energy, the echo amplitude, the FOM strength, and the FOM consistency, of each transducer 225, 240. In some embodiments, a look up table may be used to determine the ST of the fluid 105. In other embodiments, fuzzy logic may be used to determine the ST of the fluid 105.

The sonic transmissivity of fluid 105 may be used to determine an aeration coefficient of the fluid 105. In some embodiments, the aeration coefficient is a relative percentage by volume of aeration within fluid 105. In some embodiments, the aeration coefficient is determined by comparing the ST of fluid 105 contained within measurement channel 230 (an aeration ST) to the ST of fluid 105 contained within measurement channel 245 (a reference ST). In some embodiments, the aeration coefficient may be determined using a look up table and/or fuzzy logic. In other embodiment, the aeration coefficient may be determined by Equation 1 below, where A is the percentage of aeration by volume within the fluid 105 (i.e., an aeration coefficient corresponding to aeration by volume), ST_{R} is the reference ST, and ST_{A} is the aeration ST.

$$A = \frac{{ST}_{R}}{{ST}_{A}}$$

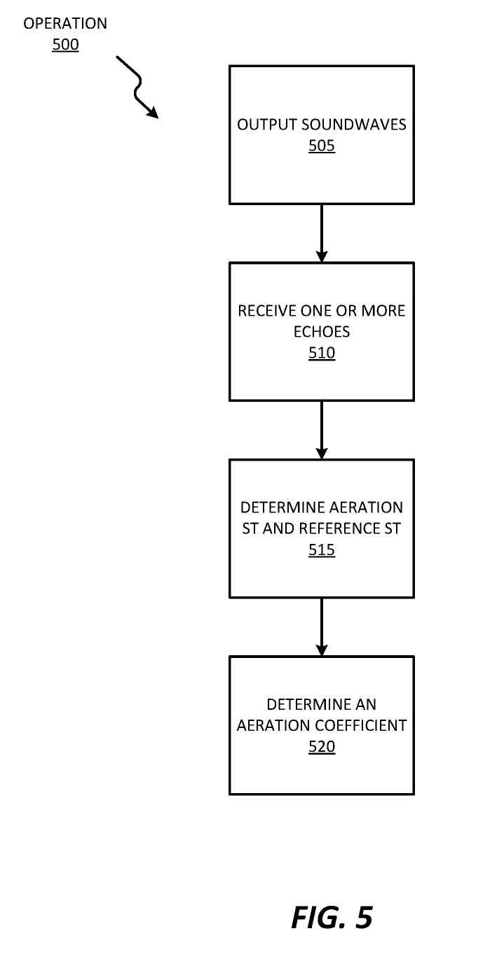

FIG. 5 illustrates a process, or operation, 500 of the system 100 according to some embodiments. It should be understood that the order of the steps disclosed in process 500 could vary. Furthermore, additional steps may be added to the process and not all of the steps may be required. Transducers 225, 240 output an aeration sound wave and a reference sound wave, respectively (block 505). Transducers 225, 240 receive one or more aeration echoes and one or more reference echoes, respectively (block 510).

Controller 405 determines an aeration sonic transmissivity (ST) and a reference sonic transmissivity (ST) (block 515). In some embodiments, the aeration ST is based at least in part on a FOM strength, a FOM consistency, a transmit energy, and an echo amplitude of the aeration sound wave and one or more received aeration echoes. Additionally, in some embodiments, the reference ST is based at least in part on a FOM strength, a FOM consistency, a transmit energy, and an echo amplitude of the reference sound wave and one or more received reference echoes.

Controller 405 determines an aeration coefficient based at least in part on the aeration ST and the reference ST (block 520). In some embodiments, the controller 405 outputs the aeration coefficient, along with one or more calculated characteristics of the fluid 105, to the external device. In some embodiments, the aeration coefficient is used to compensate for aeration in fluid 105 when determining other sensed characteristics (for example, concentration, quality, specific gravity, viscosity, level, and/or quantity).

Thus, the application provides, among other things, a system and method for determining an aeration of a fluid. Various features and advantages of the application are set forth in the following claims.

What is claimed is:

1. A fluid sensing system comprising:
a first transducer configured to output a first sound wave through a first fluid in a first measurement channel;
a second transducer configured to output a second sound wave through a second fluid in a second measurement channel;
a filter configured to substantially prevent aeration in the second fluid contained within the second measurement channel; and
a controller, having an electronic processor and memory, the controller configured to
determine a first characteristic of the first sound wave,
determine a second characteristic of the second sound wave,
determine a percentage of aeration by volume within the first fluid based on the first characteristic and second characteristic, and
output the percentage of aeration by volume within the first fluid.

2. The fluid sensing system of claim 1, wherein the percentage of aeration by volume within the first fluid is an aeration coefficient.

3. The fluid sensing system of claim 1, wherein the first characteristic is at least one selected from the group consisting of a sonic transmissivity, a figure of merit strength, a figure of merit consistency, a transmit energy, and an echo amplitude.

4. The fluid sensing system of claim 1, wherein the second characteristic is at least one selected from the group consisting of a sonic transmissivity, a figure of merit strength, a figure of merit consistency, a transmit energy, and an echo amplitude.

5. The fluid sensing system of claim 1, further comprising a temperature sensor configured to sense a temperature of at least one selected from the group consisting of the first fluid and the second fluid.

6. The fluid sensing system of claim 5, wherein the aeration coefficient is further based on the temperature.

7. The fluid sensing system of claim 1, further comprising a first reflector and a second reflector, wherein the first sound wave is reflected off of the first reflector and the second sound wave is reflected off of the second reflector.

8. The fluid sensing system of claim 1, further comprising a reflector, wherein the first sound wave is reflected off of the reflector and the second sound wave is reflected off of the reflector.

9. The fluid sensing system of claim 1, wherein the first sound wave and the second sound wave are output in a horizontal direction.

10. The fluid sensing system of claim 1, wherein the first sounds wave and the second sound wave are output in a vertical direction.

11. A method of sensing a fluid, the method comprising:
outputting, via a first transducer, a first sound wave through a first fluid;
outputting, via a second transducer, a second sound wave through a second fluid, wherein the second fluid is filtered;
determining, via a controller, a first characteristic of the first sound wave,
determining, via the controller, a second characteristic of the second sound wave,
determining, via the controller, a percentage of aeration by volume within the first fluid based on the first characteristic and the second characteristic, and
outputting the percentage of aeration by volume within the first fluid.

12. The method of claim 11, wherein the percentage of aeration by volume within the first fluid is an aeration coefficient.

13. The method of claim 1, wherein the first characteristic is at least one selected from the group consisting of a figure of merit strength, a figure of merit consistency, a transmit energy, and an echo amplitude.

14. The method of claim 1, wherein the second characteristic is at least one selected from the group consisting of a figure of merit strength, a figure of merit consistency, a transmit energy, and an echo amplitude.

15. The method of claim 11, further comprising sensing, via a temperature sensor, a temperature of at least one selected from the group consisting of the first fluid and the second fluid.

16. The method of claim 15, wherein the aeration coefficient is further based on the temperature.

17. The method of claim 11, wherein the first sound wave is reflected off of a first reflector and the second sound wave is reflected off of a second reflector.

18. The method of claim 11, wherein the first sound wave and the second sound wave are reflected off of a reflector.

19. The method of claim 11, wherein the first sound wave and the second sound wave are output in a horizontal direction.

20. The method of claim 11, wherein the first sounds wave and the second sound wave are output in a vertical direction.
